(19) United States
(12) Patent Application Publication
(10) Pub. No.: US 2008/0299246 A1
(43) Pub. Date: Dec. 4, 2008

(54) MULTIPLE-SHOT INJECTION MOLD ASSEMBLY AND A COMPONENT HAVING A RETENTION RIB MADE THEREWITH

(75) Inventors: Roger Catron, Washington, MI (US); Bernard Chan, Sterling Heights, MI (US); David Turczynski, Highland, MI (US); Dennis Bunker, Clarkston, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 11/755,272

(22) Filed: May 30, 2007

(51) Int. Cl. B28B 21/84

(52) U.S. Cl. 425/451.9; 428/500

(57) ABSTRACT

A mold assembly having a first mold portion with a first cavity having a retention groove. A second mold portion associated with the first mold portion and configured to come together therewith. The second mold portion has a second cavity. The second cavity and the first cavity form a first substrate compartment. A third mold portion is associated with the first mold portion and configured to come together therewith. The third mold portion has a third cavity having a shut-off member. The third cavity and the first cavity form a first over-mold compartment when the first and third mold portions come together. The shut-off member projects from the third cavity surface to impinge on a surface of a component formed by the first substrate compartment. The first retention groove mirrors the shut-off member and is aligned therewith when the first and third cavities form the first over-mold compartment.

### BACKGROUND OF THE INVENTION

1. Field of the Invention

The field of this invention includes multiple-shot injection molds having retention grooves and components made therewith having retention ribs.

2. Background Art

Multiple-shot injection molding commonly involves the injection molding of components using a two-stage or two-shot sequential injection molding process. During a first stage, a molten polymeric material may be introduced into a mold cavity and is retained there until the material hardens into a substrate. Then, in a second stage a portion of a surface of the mold cavity is removed or retracted or, in other applications, a different cavity is coupled with the mold having the substrate to form an internal compartment for receiving additional polymeric material which may either partially or entirely over-mold or overlap the substrate.

As the first shot hardens, the polymeric material may shrink. In applications where the mold core moves between the first and second shots, the shrinkage can cause gaps to form between a perimeter of the substrate and the mold cavity. These gaps can permit the substrate to shift or move from its original position within the cavity. This movement can cause misalignment between the substrate and a shut-off member that confines the flow of the second shot. As a result, the second shot may over-mold an unintended portion of the substrate. This can result in each component having a different appearance, which may be unacceptable to a manufacturer. This and other problems are addressed by the Applicants' invention.

### SUMMARY OF THE INVENTION

According to one aspect of the present invention, a mold assembly for multiple-shot injection molding of polymeric materials is provided. In a first embodiment, a multiple-shot injection mold assembly includes a first mold portion having a first cavity. The first cavity has a first cavity surface and the first cavity surface has a first retention groove defined therein. A second mold portion is associated with the first mold portion and is configured to come together with the first mold portion. The second mold portion has a second cavity. The second cavity has a second cavity surface. The second cavity and the first cavity cooperate to form a first substrate compartment when the first and second mold portions come together during a first cycle. A third mold portion associated with the first mold portion is provided. The third mold portion is configured to come together with the first mold portion. The third mold portion may have a third cavity. The third cavity may have a third cavity surface and a shut-off member. The third cavity and the first cavity may cooperate to form a first over-mold compartment when the first and third mold portions come together during a second cycle. The shut-off member may project from the third cavity surface such that the shut-off member impinges on a surface of a component formed by the first substrate compartment. The first retention groove has a configuration that generally mirrors the shut-off member. The first retention groove is spaced apart from, and is aligned with, the shut-off member when the first and third cavities cooperate to form the first over-mold compartment.

In at least one implementation of the first embodiment, the first mold portion is configured for movement between a first position and a second position. The first cavity may be aligned with the second cavity when the first mold portion is in the first position. The first cavity may be aligned with the third cavity when the first mold portion is in the second position. In at least one variation of this implementation, the first mold portion may be configured to rotate between the first and second positions. In another variation of this implementation, the first mold portion may further have a fourth cavity having a fourth cavity surface. The fourth cavity surface may have a second retention groove defined therein. The fourth cavity and the second cavity may cooperate to form a second substrate compartment when the fourth cavity and the second cavity come together. The fourth cavity and the third cavity cooperate to form a second over-mold compartment when the fourth cavity and the third cavity come together. In a further variation, the fourth cavity surface and the second retention groove are substantially identical to the first cavity surface and the first retention groove, respectively.

In another implementation of the first embodiment, the first retention groove may have a width that is less than a width of the shut-off member. In another implementation, the first retention groove may have a length that is substantially equal to a length of the shut-off member. In other implementations, the entire first retention groove may be disposed proximate to, and may be substantially aligned with, the shut-off member.

In another implementation, the first cavity surface may have a plurality of the first retention grooves defined therein. Each first retention groove may be disposed in substantial register with a different portion of the shut-off member when the first cavity and the third cavity come together. In a variation of this implementation, the plurality of the first retention grooves may extend for a length that is substantially equal to a length of the shut-off member.

In a second embodiment, a two-shot injection mold assembly is provided comprising a first mold portion having a first cavity that is defined by a first cavity surface. The first cavity surface may have a first retention groove defined therein. A second mold portion may be provided that is configured to mate with the first mold portion. The second mold portion may have a second cavity defined by a second cavity surface. The second cavity and the first cavity may cooperate to form a first substrate compartment when the first and second mold portions are mated during a first cycle. A third mold portion may be provided that is configured to mate with the first mold portion. The third mold portion may have a third cavity defined by a third cavity surface. The third cavity may have a shut-off member that projects from the third cavity surface. The third cavity and the first cavity may cooperate to form a first over-mold compartment when the first and third mold portions are mated during a second cycle. The first mold portion may move between a first position and a second position such that the first cavity may be aligned with the second cavity when the first mold portion is in the first position and the first cavity may be aligned with the third cavity when the first mold portion is in the second position. During the second cycle, the shut-off member may impinge on a surface of a component formed by the first substrate compartment. The first retention groove may be configured to mirror the shut-off member and may be disposed in substantial register with the shut-off member when the first and third cavities cooperate to form the first over-mold compartment. The first retention groove may have a width that is less than a width of the shut-off member.

In at least one implementation of the second embodiment, the first retention groove may extend in at least two directions that are transverse to one another along the first cavity surface. In a variation of this implementation, the first retention groove may have a length that is substantially equal to a length of the shut-off member.

In another implementation of the second embodiment, the first cavity surface may have a plurality of the first retention grooves defined therein. Each first retention groove may be disposed in substantial register with a different portion of the shut-off member when the first cavity and the third cavity are mated. In a variation of this implementation, the plurality of the first retention grooves may extend for a length that is substantially equal to a length of the shut-off member.

According to another aspect of the invention, a two-shot injection molded polymeric component is provided. In a third embodiment, the component may comprise a substrate member made from a polymeric material. The substrate member may have a show surface, a back surface disposed opposite the show surface and a rib disposed on the back surface. A show member made from a polymeric material may be over-molded onto the show surface. The show member may cover less than the entire show surface of the substrate member and the show member may have an edge that extends along a path that is aligned with, and that mirrors the rib.

In at least one implementation of the third embodiment, the rib may be substantially the same length as the edge of the show member.

In another implementation of the third embodiment, the show member may be made from a material comprising a thermoplastic elastomer and the substrate may be made from a material comprising polypropylene.

In another implementation of the third embodiment, the substrate may include a depression that is substantially aligned with the edge. In at least one variation of this implementation, the rib may have a thickness that is less than a width of the depression.

### BRIEF DESCRIPTION OF THE DRAWINGS

FIGS. 1-4 are schematic views of a mold apparatus as it cycles through various stages of the multiple shot injection molding process;

FIG. 5 is a perspective, fragmentary view of corresponding portions of two halves of a mold cavity;

FIG. 6 is a cross sectional view of the portion of the mold assembly of FIG. 4 taken along the line 6-6; and

FIG. 7 is a fragmentary plan view of a component molded with the mold assembly of FIG. 6.

### DETAILED DESCRIPTION OF THE PREFERRED EMBODIMENT(S)

Reference will now be made in detail to the illustrated embodiments of the present invention which include the best modes of practicing the invention presently known to the inventors. The following descriptions are merely exemplary in nature and are in no way intended to limit the invention, its application, or uses. The Figures are not necessarily drawn to scale. Specific details disclosed herein are not to be interpreted as limiting, but merely as a representative basis for any aspect of the invention and/or as a representative basis for teaching one skilled in the art to variously employ the present invention.

A multiple shot injection molding process commonly includes the introduction of two or more molten materials into a mold cavity to form a single component. In some applications, multiple shot injection molding involves over-molding wherein a component is partially formed during a first shot and, after being allowed to cool, a second shot of the same or different material is injected into a different portion of the cavity to partially or completely cover the first component.

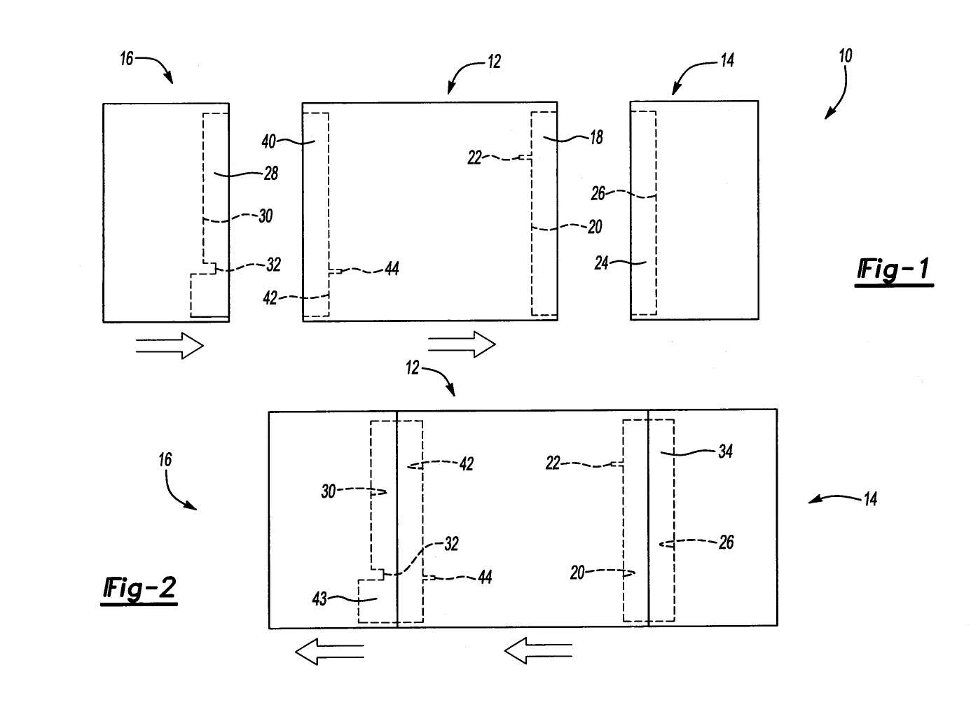

FIGS. 1-4 sequentially and schematically illustrate various stages of multiple shot injection molding using an embodiment of a mold assembly 10 of the present invention. Mold assembly 10 includes a first mold portion 12 which is configured to rotate between a first position and a second position, a second mold portion 14 and a third mold portion 16. The first mold portion 12 includes a first cavity 18 defined by a first cavity surface 20. A first retention groove 22 is defined in the first cavity surface 20. Second mold portion 14 includes a second cavity 24 defined by a second cavity surface 26. When first mold portion 12 is in the first position, the first cavity 18 faces the second cavity 24. The third mold portion 16 has a third cavity 28 defined by a third cavity surface 30 defining a shut-off member 32. When the first mold portion 12 is in the second position, first cavity 18 faces third cavity 28 and first retention groove 22 aligns with shut-off member 32.

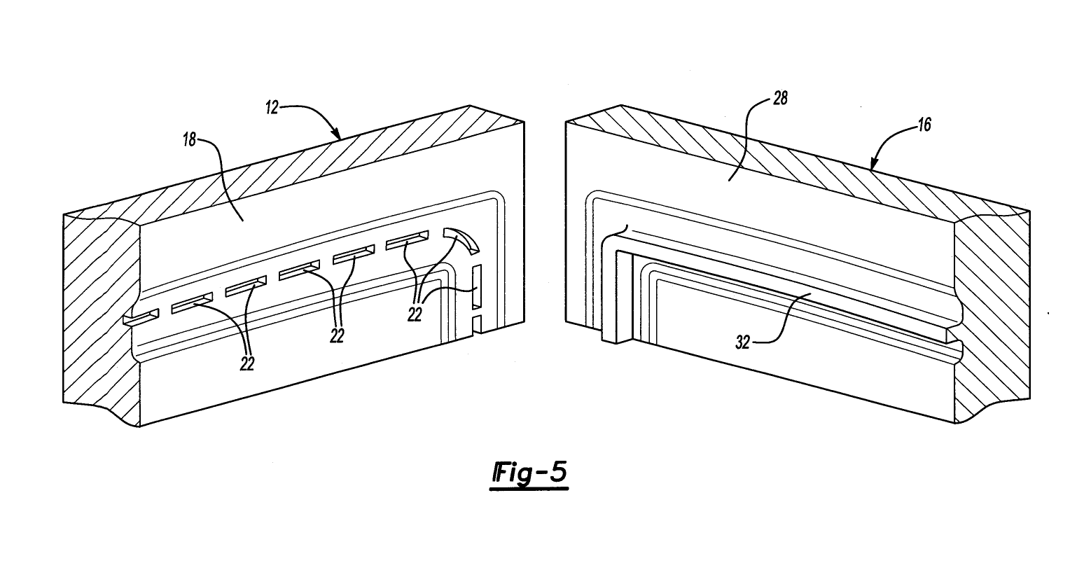

First mold portion 12 is configured to come together with second mold portion 114 as indicated by an arrow in FIG. 1. When first mold portion 12 comes together with second mold portion 14 during a first cycle, the first and second cavities 18, 24 mate to form a first substrate compartment 34 (see FIG. 2). While the first and second cavities 18, 24 are mated, a molten polymeric material, for example, polypropylene, is introduced into first substrate compartment 34. The molten polymer material takes the shape of first substrate compartment 34 and forms substrate 36. A portion of the molten polymeric material fills the first retention groove 22 to form a rib 51 (see FIG. 6) on a back surface of substrate 36. After a period of time sufficient to permit the material to solidify, the first mold portion 12 separates and moves away from the second mold portion 14 as indicated by an arrow in FIG. 2. Once first mold portion 12 has retracted, it spins as indicated in FIG. 3 from the first position to the second position to begin a second cycle. As illustrated, substrate 36 protrudes from first cavity 18 as first mold portion 12 spins towards third mold portion 16. During this movement, substrate 36 is partially immobilized within the first cavity 18 by retention rib 51. In other embodiments, substrate 36 may be partially or completely recessed within first cavity 18, and first mold portion 12 may rotate or translate between the first and second positions. In still other embodiments, first mold portion 12 may remain stationary while second and third mold portions 14, 16 move between a staging and a mating position.

During the second cycle, third mold portion 16 comes together with the first mold portion 12 as indicated by an arrow in FIG. 3. When third mold portion 16 comes together with first mold portion 12, third cavity 28 and first cavity 18 form a first over-mold compartment 38. Shut-off member 32 impinges on substrate 36 in a region of substrate 36 corresponding to rib 51, bisecting first over-mold compartment 38 into two separate sections. A second molten polymeric material, for example, a thermoplastic elastomer, is introduced into first over-mold compartment 38. The second molten polymeric material fills the portion of first over-mold compartment 38 below the shut-off member 32 to form an over-mold portion 48 (see FIG. 6). The flow of the second molten polymeric material into the remainder of the first over-mold compartment 38 is confined by the shut-off member. After a period of time sufficient to allow the second material to solidify, the third mold portion 58 retracts and component 36 is ejected (not shown).

In the illustrated embodiment, first mold portion 12 includes a fourth cavity 40 defined by a fourth cavity surface 42. A second retention groove 44 is defined in the fourth cavity surface 42. Fourth cavity 40, fourth cavity surface 42 and second retention groove 44 are substantially identical to first cavity 18, first cavity surface 20 and first retention groove 22, respectively. When first mold portion 12 is in the second position, fourth cavity 40 is aligned with second cavity 24. When third mold portion 16 comes together with the first mold portion 12 to make over-mold portion 48, first mold portion 12 may simultaneously come together with the second mold portion 14 such that fourth cavity 40 and second cavity 24 mate to form a second substrate compartment 41 for making the next substrate 46. When the first mold portion returns the first position, the fourth cavity 40 faces the third cavity 28. When third mold portion 16 comes together with the first mold portion 12, fourth cavity 40 and third cavity 28 mate to form a second over-mold compartment 43 (see FIG. 2). By including fourth cavity 40 in first mold portion 12, an operator can double the effective cycle rate of mold assembly 10.

Spinning first mold portion 12 end over end, as illustrated in FIG. 3, together with the shrinkage that may occur as molten polymeric material cools can cause the substrate of component 36 to be jostled or move slightly. The first retention groove 22 cooperates with retention rib 51 to at least partially anchor substrate 36 as the first mold portion 12 spins.

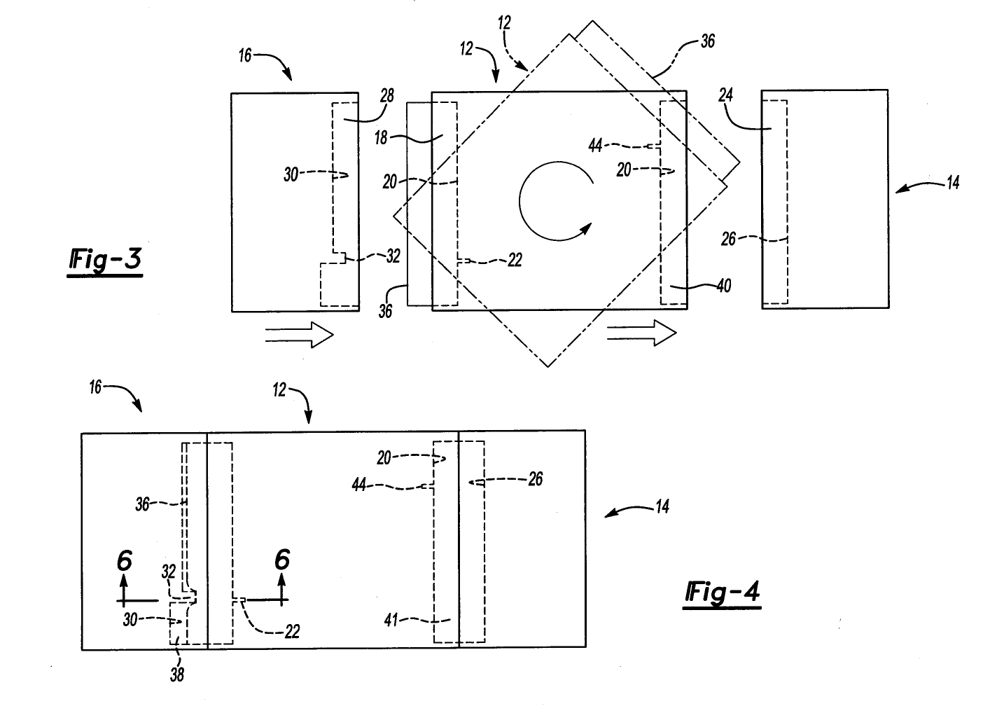

With reference to FIG. 5, a portion of the first cavity 18 and a corresponding portion of third cavity 28 are illustrated. In this view, retention groove 22 is illustrated as a plurality of discrete grooves which mirror and align with shut-off member 32. In other embodiments, the gaps between the discrete groove portions of first retention groove 22 may be larger. In still other embodiments, first retention groove 22 may be a single, continuous groove. By mirroring and aligning with shut-off member 32, first retention groove 22 anchors substrate 36 in a region corresponding to the region where shut-off member 32 impinges upon substrate 36. Arranging the retention 22 groove in this manner allows shut-off member 32 to consistently impinge upon the same region of each substrate 36.

FIG. 6 illustrates a fragmented cross section of first mold portion 12 and third mold portion 16 after they have come together to form the first over-mold compartment 38 and after a molten polymeric material has been introduced to form the over-mold portion 48. As illustrated, retention rib 51 is integrally molded with substrate 46. First retention rib 51 cooperates with retention groove 22 to obstruct movement of substrate 46 in either an upward or downward direction. First retention groove 22 and rib 51 also extends in a direction at least partially transverse to the direction illustrated in FIG. 6 (See FIG. 5). This transverse arrangement permits retention rib 51 and retention groove 22 to cooperate to obstruct movement of substrate 46 from side to side which further contributes to consistent proper alignment of substrate 46.

As illustrated in FIG. 6, first retention groove 22 is narrower than shut-off member 32. In other embodiments, first retention groove 22 may have a thickness that is equal to or greater than shut-off member 32.

Substrate 46 has a show surface 50 and a back surface 52. Show surface 50 is intended to be visible while back surface 52 is intended to be concealed. For example, in applications where component 58 forms a portion of an automotive door panel, show surface 50 may face internally into a passenger compartment and may be visible to occupants thereof while back surface 52 would face away from the passenger compartment and not visible from the interior of the vehicle. Gap 54 is provided to prevent marring or otherwise disfiguring show surface 52 as third cavity 28 and first cavity 18 mate to form first over-mold compartment 38. In other embodiments, both the show surface 52 and the back surface may remain visible.

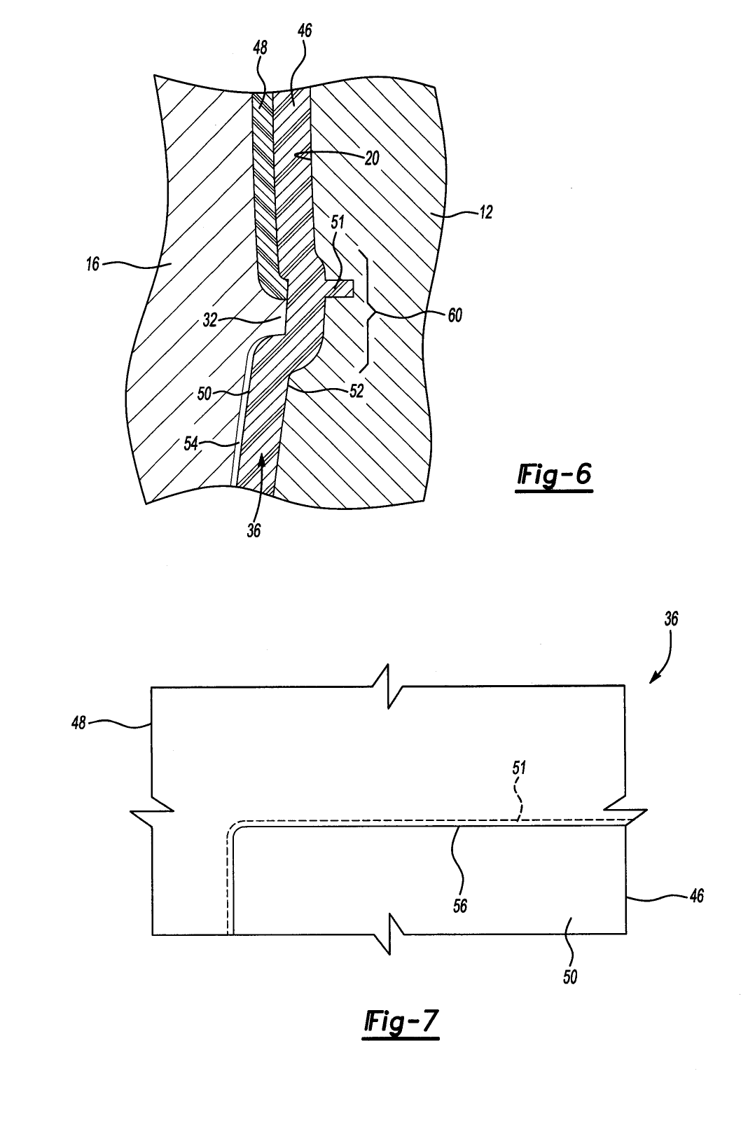

FIG. 7 illustrates a fragmented portion of component 58. Show surface 50 of substrate 46 are visible at a lower portion of component 58 while over-mold portion 48 is visible at an upper portion of component 58. Retention rib 51, illustrated in phantom lines, is disposed along the back surface 52 of substrate 36. Retention rib 51 substantially mirrors, and is aligned with, an edge 56 of over-mold portion 48. Retention rib 51 continues to follow edge 56 along substantially the entire length of edge 56.

Substrate 46 further includes a depressed portion 60 which brackets and parallels retention groove 22 along substantially the entire length of retention groove 22. Depression 60 serves to accommodate the impingement of shut-off member 32 into substrate 46. The presence of depression 60 in the first cavity 18 helps to reduce the stress in substrate 46 caused by the impingement of shut-off member 32.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A multiple-shot injection mold assembly comprising:
a first mold portion having a first cavity having a first cavity surface, the first cavity surface having a first retention groove defined therein;
a second mold portion associated with the first mold portion and configured to come together therewith, the second mold portion having a second cavity having a second cavity surface, the second cavity and the first cavity cooperating to form a first substrate compartment when the first and second mold portions come together during a first cycle; and
a third mold portion associated with the first mold portion and configured to come together therewith, the third mold portion having a third cavity having a third cavity surface and a shut-off member, the third cavity and the first cavity cooperating to form a first over-mold compartment when the first and third mold portions come together during a second cycle,
wherein the shut-off member projects from the third cavity surface such that the shut-off member impinges on a surface of a component formed by the first substrate compartment; and
wherein the first retention groove has a configuration that generally mirrors the shut-off member and wherein the first retention groove is spaced apart from, and is aligned with, the shut-off member when the first and third cavities cooperate to form the first over-mold compartment.

2. The multiple-shot injection mold assembly of claim 1 wherein the first mold portion is configured for movement between a first position and a second position, the first cavity being aligned with the second cavity when the first mold portion is in the first position and the first cavity being aligned with the third cavity when the first mold portion is in the second position.

3. The multiple-shot injection mold assembly of claim 2 wherein the first mold portion is configured to rotate between the first and second positions.

4. The multiple-shot injection mold assembly of claim 2 wherein the first mold portion further has a fourth cavity having a fourth cavity surface, the fourth cavity surface having a second retention groove defined therein, the fourth cavity and the second cavity cooperating to form a second substrate compartment when the fourth cavity and the second cavity come together, the fourth cavity and the third cavity cooperating to form a second over-mold compartment when the fourth cavity and the third cavity come together.

5. The multiple-shot injection mold assembly of claim 4 wherein the fourth cavity surface and the second retention groove are substantially identical to the first cavity surface and the first retention groove, respectively.

6. The multiple-shot injection mold assembly of claim 1 wherein the first retention groove has a width that is less than a width of the shut-off member.

7. The multiple-shot injection mold assembly of claim 1 wherein the first retention groove has a length that is substantially equal to a length of the shut-off member.

8. The multiple-shot injection mold assembly of claim 1 wherein the entire first retention groove is disposed proximate to and substantially aligned with the shut-off member when the first and third cavities cooperate to form the first over-mold compartment.

9. The multiple-shot injection mold assembly of claim 1 wherein the first cavity surface has a plurality of the first retention grooves defined therein and wherein each first retention groove is disposed in substantial register with a different portion of the shut-off member when the first cavity and third cavity come together.

10. The multiple-shot injection mold assembly of claim 9 wherein the plurality of the first retention grooves extends for a length that is substantially equal to a length of the shut-off member.

11. A two-shot injection mold assembly comprising:
a first mold portion having a first cavity defined by a first cavity surface, the first cavity surface having a first retention groove defined therein;
a second mold portion configured to mate with the first mold portion and the second mold portion having a second cavity defined by a second cavity surface, the second cavity and the first cavity cooperating to form a first substrate compartment when the first and second mold portions are mated during a first cycle; and
a third mold portion configured to mate with the first mold portion, the third mold portion having a third cavity defined by a third cavity surface, the third cavity having a shut-off member that projects from the third cavity surface, the third cavity and the first cavity cooperating to form a first over-mold compartment when the first and third mold portions are mated during a second cycle,
wherein the first mold portion moves between a first position and a second position such that the first cavity is aligned with the second cavity when the first mold portion is in the first position and the first cavity is aligned with the third cavity when the first mold portion is in the second position, and
wherein, during the second cycle, the shut-off member impinges on a surface of a component formed by the first substrate compartment, and
wherein the first retention groove is configured to mirror the shut-off member and is disposed in substantial register with the shut-off member when the first and third cavities cooperate to form the first over-mold compartment, the first retention groove having a width that is less than a width of the shut-off member.

12. The two-shot injection mold assembly of claim 11 wherein the first retention groove extends in at least two directions that are transverse to one another along the first cavity surface.

13. The two-shot injection mold assembly of claim 12 wherein the first retention groove has a length that is substantially equal to a length of the shut-off member.

14. The two-shot injection mold assembly of claim 11 wherein the first cavity surface has a plurality of the first retention grooves defined therein and wherein each first retention groove is disposed in substantial register with a different portion of the shut-off member when the first cavity and third cavity are mated.

15. The two-shot mold assembly of claim 14 wherein the plurality of the first retention grooves extends along a path having a length that is substantially equal to a length of the shut-off member.

16. A two-shot injection molded polymeric component comprising:
a substrate member made from a polymeric material and having a show surface, a back surface disposed opposite the show surface, and a rib disposed on the back surface; and
a show member made from a polymeric material and over-molded onto the show surface, the show member covering less than the entire show surface of the substrate member, the show member having an edge that extends along a path that is aligned with, and that mirrors the rib.

17. The two-shot injection molded polymeric component of claim 16 wherein the rib is substantially the same length as the edge of the show member.

18. The two-shot injection molded polymeric component of claim 16 wherein the show member is made from a material comprising a thermoplastic elastomer and wherein the substrate member is made from a material comprising polypropylene.

19. The two-shot injection molded polymeric component of claim 16 wherein the substrate includes a depression that is substantially aligned with the edge.

20. The two-shot injection molded polymeric component of claim 19 wherein the rib has a thickness less than a width of the depression.
